(19) United States
(12) Patent Application Publication
(10) Pub. No.: US 2025/0290759 A1
(43) Pub. Date: Sep. 18, 2025

(54) Method for Localizing a Motor Vehicle

(71) Applicant: Robert Bosch GmbH, Stuttgart (DE)

(72) Inventor: Marcus Wagner, Schwaigern (DE)

(21) Appl. No.: 19/080,820

(22) Filed: Mar. 15, 2025

(30) Foreign Application Priority Data
Mar. 18, 2024 (DE) 10 2024 202 513.5

(51) Int. Cl. G01C 21/30; G01S 19/48; G06T 7/73

(52) U.S. Cl. CPC G01C 21/30; G01S 19/485; G06T 7/74; G06T 2207/30252

(57) ABSTRACT

A method for localizing a motor vehicle includes (a) receiving image data acquired with an upward-facing camera disposed on the motor vehicle and with a fish eye lens and an upward-facing axis of view, and (b) performing localization to determine a position of the motor vehicle using the image data received in step (a).

This application claims priority under 35 U.S.C. § 119 to application no. DE 10 2024 202 513.5, filed on Mar. 18, 2024 in Germany, the disclosure of which is incorporated herein by reference in its entirety.

### BACKGROUND

The disclosure relates to a method for localizing a motor vehicle. A plurality of environmental sensors is typically used to localize vehicles. These sensors, such as lidar, radar, or video cameras, can be used to monitor the environment of a vehicle. The data obtained with these sensors is evaluated in motor vehicles with controllers and computers on which filters are implemented with which localizations and position determinations can be carried out.

Described herein is a new approach for obtaining data for localization with sensors and performing localization based on the data obtained with the sensors.

### SUMMARY

Described herein is a method of localizing a motor vehicle comprising the steps of
a) receiving image data acquired with an upward-facing camera disposed on the motor vehicle with a fish eye lens and an upward-facing axis of view; and
b) performing localization to determine a position of the motor vehicle using the image data received in step a).

Preferably, the vehicle is a passenger vehicle. However, the method is equally suitable for different types of motor vehicles. The camera is in particular a video camera that can be used to continuously detect current image data from the environment of the motor vehicle. In the context of the described method, the camera is an environmental sensor by which the environment of the motor vehicle can be monitored.

By localization, in particular, is meant the determination of a position where the vehicle is located at a particular time (at the time of localization).

The camera used here has a fish eye lens. A fish eye lens is a specialized lens that can have a very wide viewing angle (extreme wide-angle lens) and, in particular, can depict a complete field of view. In contrast to conventional non-fish eye lenses that proportionally depict an object plane perpendicular to the optical axis (gnomonic projection mode), fish eye lenses depict a hemisphere or even a larger proportion of a sphere with distinct but not excessive distortions on the image plane. The projection of a fish eye lens is thus preferably not gnomonic, but rather carried out by depicting a hemisphere. Even lines that do not pass through the center of the image are depicted as curved by fish eye lenses. Area ratios or radial spacing are typically more accurately depicted by fish eye lenses than a regular, gnomonically projecting wide-angle lens. The angle of view from a fish eye lens is often 180°; in extreme cases the angle of view may even be up to 220°. Such extreme angles of view are not achievable with conventional (in particular gnomonic) projection modes. Despite the exceptionally large angle of view, the drop in brightness towards the edge of the image is more easily correctable when using fish eye lenses than with wide-angle lenses because the magnification does not increase as sharply towards the edge of the image and the light does not have to illuminate areas that are quite as large.

By using a fish eye lens to obtain image data with the camera, a type of image data is generated that provides new and particularly advantageous possibilities for performing localizations. The localization methods and technologies possible with such image data are in particular characterized in that they can be carried out efficiently (with reduced computational effort). Moreover, methods and technologies for localization based on such image data have the advantage that the image data requires no or only little enrichment with further data in order to obtain relevant information from this image data.

By using the camera with a fish eye lens, very comprehensive information can be acquired with only one camera (only one sensor).

Particularly in light of the fact that the camera is oriented upward, the image data obtained with the camera is initially quite independent of the current state of the vehicle. Preferably, in step a), image data is received that covers a hemisphere surrounding the vehicle as fully as possible. This image data already includes highly relevant information on the environment of the vehicle, which can regularly be used directly to generate relevant information for autonomous or highly automated driving functions.

It is particularly preferable if localization of the motor vehicle in step b) is carried out by comparing the image data to map data representing a street situation.

Preferably, image data depicts a situation located above the motor vehicle, which is referred to herein as a street situation. Depending on how large the angle of view of the fish eye lens is, the image data received in step a) also includes information about the surrounding environment of the vehicle in the plane in which the vehicle is located. At a viewing angle of 180 degrees, the image data also includes, in particular, image information regarding the situation at the height of the plane on which the vehicle is located. This image data is located in particular in the peripheral area of images contained in the image data.

In addition, it is further preferable if street signs are detected in step b) in the image data that is compared to map data in order to perform the localization.

Street signs are typically affixed to elevated signs surrounding the roadway. Street signs regularly state the names of the streets on which the street signs are located. Such a localization can be carried out by way of a comparison based on street name information in the map data. Particularly preferably, map data also includes exact coordinates of street signs positioned along a street. If street signs have been detected using the described method, localization may be carried out via coordinates of the respective street sign stored in the map data.

Moreover, it is preferable if houses are detected in the image data that is compared to map data to perform a localization.

For example, it is possible that outlines of houses may be detected in map data that may be recognized in the image data for localization. In further design variants, it is also possible that facades of houses may be detected in map data that may be recognized in the image data for localization. Performing localization by detecting houses is carried out in particular in urban situations with a high level of development adjacent the roadway on which the vehicle is located.

In addition, it is preferable if, in step b), a clear field of view above the motor vehicle is detected with the image data, wherein GNSS satellite signals are selected taking into account the clear viewing area in order to perform the localization.

Moreover, it is preferable when selecting GNSS satellite signals in step b) that GNSS satellites be selected whose axis of view to the motor vehicle passes through the clear field of view.

A significant difficulty in determining localizations using GNSS signals from GNSS satellites (e.g. GPS, Beidou and/or GLONASS) is the shielding of visible satellites by tall objects in the surrounding environment, as well as the distortion of GNSS satellite signals by signal reflections and multipath effects. Excluding satellites from the position determination to which there is no direct line of sight from the signal receiver is a very reliable method to improve the accuracy of the position determination using GNSS satellite signals. In practice, however, it is regularly difficult to recognize which satellites are or are not in a direct line of sight.

Here, it is now proposed to use image data from the upwardly oriented camera with the fish eye lens to detect a clear field of view above the motor vehicle. The clear field of view detected in step b) is preferably cone-shaped and describes a cone extending upwardly from the vehicle. With the aid of image data from the camera, such a cone or the clear field of view can very easily determine based said image data on how wide or large the clear area is in the image data. Typically, a hemisphere surrounding the fish eye lens is projected onto a plane with the fish eye lens. Preferably, a distance from an image center point in the image data may be converted to an angle between an axis of view of the camera or fish eye lens. A circle in the image data around the image center point corresponds to a cone within the hemisphere. The radius of such a circle preferably corresponds to the angle of the cone. Such a cone may be determined very efficiently from the image data. Such a cone may be used to select GNSS satellites to perform a localization. From path data, it is preferably known where certain GNSS satellites are visible and at what angle the GNSS satellite signals of these satellites will arrive at the vehicle. These angles can be matched to the clear field of view obtained from the image data. Only if the axes of view of the satellites pass through the clear field of view (or cone) are these satellites used to perform the localization.

In design variants of the described method, the clear field of view can not only be defined in the form of a cone. Due to common situations (e.g. in a developed surrounding environment), the horizon is often much further away from or lower starting from a vehicle in the direction of travel than transverse to the direction of travel. In other words: Along a travel path, the horizon is low. On the side of the travel path, the horizon is regularly bounded by adjacent buildings. Based on the data obtained with the fish eye lens camera, the angle of the horizon is determined, respectively, preferably along the entire circumference of the fish eye lens (around the axis of view), to define the clear field of view. In this way, the actual clear field of view starting from the motor vehicle is detected very accurately. The number of GNSS satellites that are unnecessarily (without need) excluded from localization can thus be reduced.

In addition, it is preferable if the fish eye lens has an angle of view greater than 160 degrees.

Particularly preferably, the angle of view is even 180 degrees or more, so that everything is detected by the camera up to the plane on which the camera or vehicle is located.

Moreover, it is preferable if the axis of view of the fish eye lens deviates by a maximum of 10 degrees from a perpendicular direction of the motor vehicle.

Preferably, the axis of view of the camera with the fish eye lens is mounted exactly in a perpendicular direction to the motor vehicle, wherein the perpendicular direction is perpendicular when the vehicle is on a level standing surface. When the vehicle is on an obliquely aligned surface, the axis of view is inclined according to the slope of the standing surface.

A control unit for a motor vehicle configured to perform the described method is also to be described herein.

A motor vehicle comprising an upwardly oriented camera with a fish eye lens and at least one described controller which is configured to perform the described method is also to be described herein.

### BRIEF DESCRIPTION OF THE DRAWINGS

The disclosure and the technical environment of the disclosure will be explained in more detail in the following with reference to the figures. The figures show preferred exemplary embodiments to which the disclosure is not limited. It should in particular be noted that the figures and in particular the size relationships shown in the figures are merely schematic. The figures show:

FIG. 1: a motor vehicle described;

FIG. 2: an example of image data;

FIG. 3: an example of map data

FIG. 4: an explanation of the clear field of view; and

FIG. 5: a flow chart of the described method.

### DETAILED DESCRIPTION

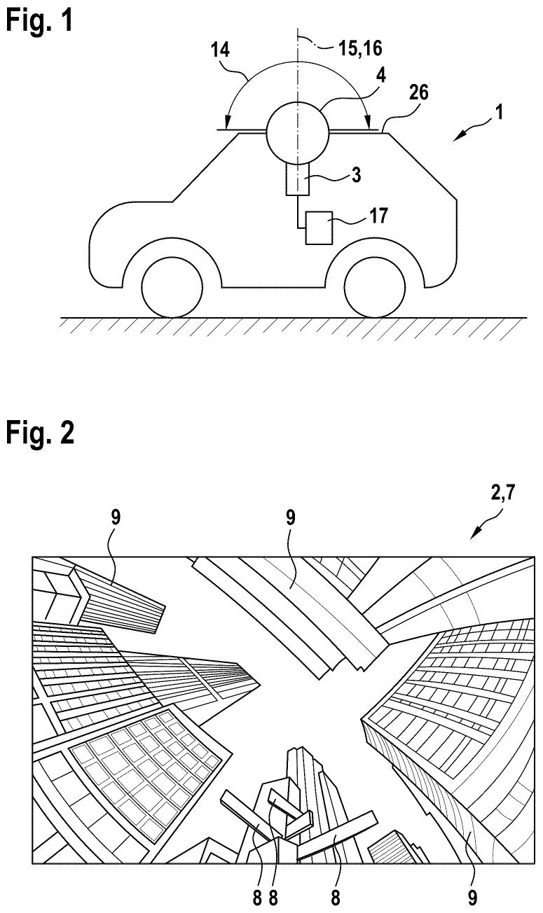

FIG. 1 shows a motor vehicle 1 described with a camera 3 with a fish eye lens 4. The camera 3 is mounted on the roof 26 of the motor vehicle 1 here in order to have a very good all-round view for monitoring the complete surrounding environment of the motor vehicle 1.

The camera 1 has an axis of view 15. The axis of view 15 of the camera is preferably aligned according to a perpendicular direction 16. The center point of an image generated with the camera 3 is on the axis of view 15. The camera 3 or the fish eye lens 4 has an angle of view 14, which defines an area detectable with the camera 3 around the image axis 15 and which is 180 degrees here. With this camera 3, a complete hemisphere around the motor vehicle 1 can be detected. If necessary, the camera may be positioned even higher than the roof 26 by a distance. This is particularly advantageous if the angle of view 14 of the camera 3 or the fish eye lens 4 is even more than 180 degrees. The camera 3 can then also be used to monitor the plane 27 on which the motor vehicle 1 is located (standing surface). Preferably, the motor vehicle 1 comprises a control unit 17 or a computer in which the method described herein is implemented.

FIG. 2 shows an example of image data 2 that may be detected with the camera. A street situation 7 is to be detected in the image data 2, which is characterized by tall houses 9 standing in the surrounding vicinity of the roadway on which the motor vehicle 1 is located. Street signs 8 are also to be detected. Localization can be carried out, for example, by detecting the houses 9 in map data and/or by evaluating the street signs 8.

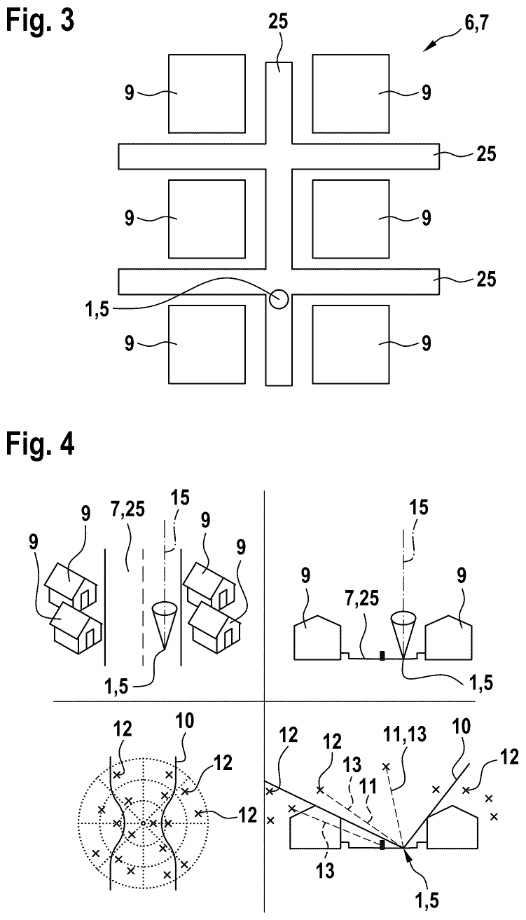

FIG. 3 schematically shows map data 6 showing, for example, the street situation 7 depicted in FIG. 2. The position 5 of the motor vehicle 1 is to be detected in this map data 6. The street 25 on which the motor vehicle 1 is located as well as further streets 25 are also to be detected. The position 5 can be achieved by comparing the image data 2 with the map data 6.

In FIG. 4, the determination of a clear field of view 10 is explained using the described method. In the upper region of FIG. 4, a street situation 7 is illustrated in which the motor vehicle 1 is located at a position 5. A three-dimensional schematic view of the situation is shown on the left. On the right, the same situation is shown from a horizontal perspective. Houses 9 on both sides of the street 25 on which the motor vehicle 1 is located are to be detected. The axis of view 15 of the camera (not shown separately here) toward the motor vehicle 1 is respectively indicated.

The lower region of FIG. 4 illustrates how a clear field of view 10 is influenced by the street situation 7 with the houses 9. The clear field of view 10 along the street 25 is configured by the houses 9 and is particularly narrowed directly to the right and left of the motor vehicle 1. In the image data, an angle of the horizon relative to the axis of view 15 of the camera 3 can be detected in any direction in the plane around the vehicle. In this way, the clear field of view 10 can be effectively determined.

In the lower left region, the clear field of view 10 is illustrated in a projection from the top. Each of the GNSS satellites 12 is illustrated as a cross. There is a free axis of view 13 to each of the GNSS satellites 12 within the clear field of view 10 which is not disturbed by the houses 9, so that GNSS signals 11 from the GNSS satellites 12 can reach the vehicle 1 directly/on a direct path. The axes of view 13 to the GNSS satellites 12 outside of the clear field of view 10 are disturbed.

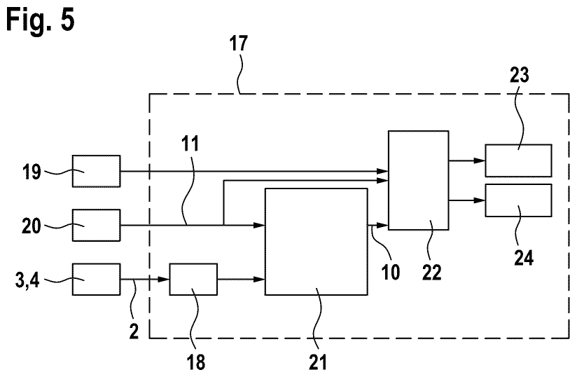

In the lower right region of FIG. 4, this can be seen even better in a horizontal perspective. FIG. 5 shows a flowchart of the described method, which may be performed in a controller 17 or a computer of a motor vehicle 1. Schematically shown is the camera 3 with the fish eye lens 5 that generates image data 2. The image data 2 is preferably fed to an object detection 18 in controller 17 for performing the described method, with which objects are detected in the image data 2. The image data 2 processed in this way (including preferably also data regarding objects in the surrounding vicinity of the motor vehicle 1) is then fed to a field of view detection 21. In design variants, data from a GNSS receiver 20, which in particular comprise GNSS signals 11, can also be included for the field of view detection 21. Output data of the field of view detection 21, which in particular describes the clear field of view 10, as well as the data from the GNSS receiver 20 and, if applicable, data from IMU sensors (inertial sensors) 19 are merged in a sensor fusion 22. From this, localizations 23 and, if necessary, also additional speed determinations 24 are carried out to determine the speed of the motor vehicle 1.

What is claimed is:

1. A method for localizing a motor vehicle, comprising:
a) receiving image data acquired with an upward-facing camera disposed on the motor vehicle with a fish eye lens and an upward-facing axis of view; and
b) performing a localization to determine a position of the motor vehicle using the image data received in step a).

2. A method according to claim 1, wherein in step b) the localization of the motor vehicle is carried out by comparing the image data with map data depicting a street situation.

3. A method according to claim 2, wherein in step b) street signs are detected in the image data that are compared to map data to perform the localization.

4. A method according to claim 2, wherein in step b) houses are detected in the image data that are compared to map data to perform a localization.

5. A method according to claim 1, wherein in step b) a clear field of view above the motor vehicle is detected with the image data, and wherein GNSS satellite signals are selected for performing the localization taking into account the clear field of view.

6. A method according to claim 5, wherein in step b) GNSS satellite signals are selected from GNSS satellites whose axis of view runs to the motor vehicle through the clear field of view.

7. A method according to claim 1, wherein the fish eye lens has an angle of view of more than 160 degrees.

8. A method according to claim 1, wherein the axis of view of the fish eye lens deviates a maximum of 10 degrees from a perpendicular direction of the motor vehicle.

9. A controller for a motor vehicle configured to perform the method according to claim 1.

10. A motor vehicle, comprising:
an upward-facing camera with a fish eye lens, and
at least one controller according to claim 9.
